(19) United States
(12) Patent Application Publication
(10) Pub. No.: US 2008/0257428 A1
(43) Pub. Date: Oct. 23, 2008

(54) ACTUATING DRIVE

(75) Inventors: Wolfgang Scholz, Minden (DE); Frank Marks, Duesseldorf (DE)

Correspondence Address: BUCHANAN, INGERSOLL & ROONEY PC, POST OFFICE BOX 1404, ALEXANDRIA, VA, 22313-1404, US

(73) Assignee: ABB AG, Mannheim (DE)

(21) Appl. No.: 12/107,856

(22) Filed: Apr. 23, 2008

(30) Foreign Application Priority Data
Apr. 23, 2007 (DE) 10 2007 019 045.1

(51) Int. Cl. F16K 37/00; G05B 19/29; G01B 11/14

(52) U.S. Cl. 137/554; 356/620; 700/259

(57) ABSTRACT

The disclosure relates to an actuating drive for control of an actuating element for automation in process installations. An exemplary actuating device drive for control of an actuating element comprising: a position detection device configured for detection of an actual position of the actuating element; a regulator unit configured for operational connection with the position detection device for comparison of an actual position with a predeterminable set position and for production of an actuating signal for driving the actuating drive, wherein the position detection device has a pattern support, at least part of whose surface is covered by a pattern which can be scanned optically; and a stationary optical scanning device, whose optical axis is aligned with the pattern.

### RELATED APPLICATION

This application claims priority under 35 U.S.C. §119 to German Patent Application No. 10 2007 019 045.1 filed in Germany on Apr. 23, 2007, the entire content of which is hereby incorporated by reference in its entirety.

### TECHNICAL FIELD

An actuating drive for control of actuating elements for automation in process installations is disclosed.

### BACKGROUND INFORMATION

Known actuating drives are equipped with a control device which compares the instantaneous actual position of the actuating element with a predetermined set position, and drives the actuating drive such that the actual position is changed, for compensation purposes, in the direction of the predetermined set position. For this purpose, the actuating drive has a position sensor arrangement, which signals the instantaneous actual position of the actuating element to the control device.

DE 42 39 635 A1 discloses a method for detecting the position of the valve rod movement for electropneumatic position regulators, in which method, in an inductively operating sensor, an RF oscillation is excited within an LC resonant circuit in order to produce a radio-frequency electromagnetic alternating field, which is attenuated as a function of the movement distance via an electrically conductive body which is also moved by the valve rod, and in which the oscillator signal is demodulated and is supplied, without being amplified, to a microcomputer in order to evaluate the position-dependent oscillation amplitude attenuation. Although this method allows non-contacting position measurement, the hardware complexity for carrying out the method can be quite high, however, and the measurement accuracy can be inadequate, in particular in the event of vibration in rough installation operation.

Furthermore, it is already known as prior art from DE 42 39 635 A1 for potentiometers, capacitive sensors and differential transformers to be used for position measurement on valve rods, with these devices being operated by means of a lever tap on the valve rod. These already known solutions have many disadvantages. For example, potentiometers are generally subject to wear, particularly when they are used in an area in which severe mechanical vibration or shaking occurs. This wear is evident by increasing wear at the operating point of the potentiometer. The use of rotary capacitors can be very expensive, since complex protective measures can be instituted in this case against moisture and, furthermore, very precise mechanical bearings are used. The use of differential transformers can be disadvantageous because of the expensive mechanical bearing, since lateral movements of the magnet in the coil are suppressed. The electronics which are required in a corresponding manner for supply are also too expensive and have a relatively high power consumption.

DE 100 16 636 A1 discloses a position regulator, in particular for a valve which can be operated by a drive, having a position transmitter for detection of the actual position of an actuating element and having a regulator unit for comparison of the actual position with a predeterminable set position and for producing an actuating signal, in which a magnet and a magneto resistive sensor are provided as the position transmitter and can be rotated or moved relative to one another in a corresponding manner to a movement of the actuating element.

### SUMMARY

An actuating drive is enclosed for control of an actuating element comprising: a position detection device configured for detection of an actual position of the actuating element; a regulator unit configured for operational connection with the position detection device for comparison of an actual position with a predeterminable set position and for production of an actuating signal for driving the actuating drive, wherein the position detection device has a pattern support, at least part of whose surface is covered by a pattern which can be scanned optically; and a stationary optical scanning device, whose optical axis is aligned with the pattern.

### BRIEF DESCRIPTION OF THE DRAWINGS

The disclosure will be explained in more detail in the following text with reference to exemplary embodiments. In the figures:

FIG. 1 shows an outline illustration of an exemplary actuating drive, which is operated by a pressure medium, with a process valve;

FIG. 2 shows an outline illustration of an exemplary position detection device with a pattern support disk; and

FIG. 3 shows an outline illustration of an exemplary position detection device with a pattern support in the form of a roller.

### DETAILED DESCRIPTION

An actuating drive as disclosed herein can include means for detection of the position of an actuating element, which means can have a high measurement accuracy while drawing little current, and are insensitive to vibration.

An exemplary actuating drive for control of an actuating element can include a position detection device configured for detection of the actual position of the actuating element and a regulator unit configured for operational connection with the position detection device for comparison of an actual position with a predeterminable set position and for production of an actuating signal for driving the actuating drive.

In an exemplary embodiment, the position detection device which is associated with the actuating drive has a pattern support, at least part of whose surface is covered by a pattern which can be scanned optically. Furthermore, a stationary optical scanning device can be provided, whose optical axis is aligned with the pattern.

The pattern support and the scanning device can be mechanically separated from one another, so that mechanical shaking and vibration which is transmitted from the actuating drive to the position detection device can be kept away from the scanning device. The vibration which is transmitted to the pattern support and is evident in the form of a periodic pattern change in the optical axis of the scanning device can be eliminated by averaging of the scan signal. The position detection device can, for example, be insensitive to mechanical shaking and vibration.

According to a further exemplary feature, the pattern support is rotationally symmetrical in the form of a disk, and the pattern is arranged radially on the pattern support. In this case, the optical axis of the scanning device can be at right angles to the disk plane and parallel to the axis of symmetry of the pattern support. Whenever the position of the actuating element changes, the pattern support can be appropriately readjusted by rotation about its axis of symmetry, which coincides with the rotation axis. The pattern change at the focus of the scanning device can be identified as a change in the actual position of the actuating element.

According to a further exemplary feature, the pattern support can be in the form of a roller, and the pattern arranged on a casing of the pattern support. In this case, the optical axis of the scanning device is at right angles to the casing and to the axis of symmetry of the pattern support. Whenever the position of the actuating element changes, the pattern support can be appropriately readjusted by rotation about its axis of symmetry, which coincides with the rotation axis. The pattern change at the focus of the scanning device can be identified as a change in the actual position of the actuating element.

According to a further exemplary feature, the pattern support can be illuminated by an intermittent light source. In consequence, the position detection device can use less energy than if the pattern support were to be illuminated continuously. Furthermore, this operating mode is similar to discontinuous operation of sequentially operated optical scanning devices and downstream processing means.

Further exemplary features of the disclosure provide for the pattern to be in the form of a circumferential track, which has an annular shape or a shape in the form of a tire, dependent on the geometric shape of the pattern support. Even if the circumferential track is scanned only partially for position detection during correct use, over a segment which corresponds to the movement of the actuating element, then the completely circumferential track on the pattern support can have an advantage that the pattern support can initially be mounted in any desired angular position with respect to the scanning device, and the initial and final values of the scanning range can be determined just once during an initialization process on commissioning. This can avoid human errors in adjustment.

Further exemplary features provide for the pattern to be in the form of concentrically circumferential, annular tracks that are coincident on both disk faces of the pattern support, which is in the form of a disk. Irrespective of the installation orientation, in an exemplary embodiment, one of the tracks can be always at the focus of the scanning device, and the instantaneous position of the actuating element can thus be detected. A pattern support in this form can be advantageously insensitive to incorrect installation.

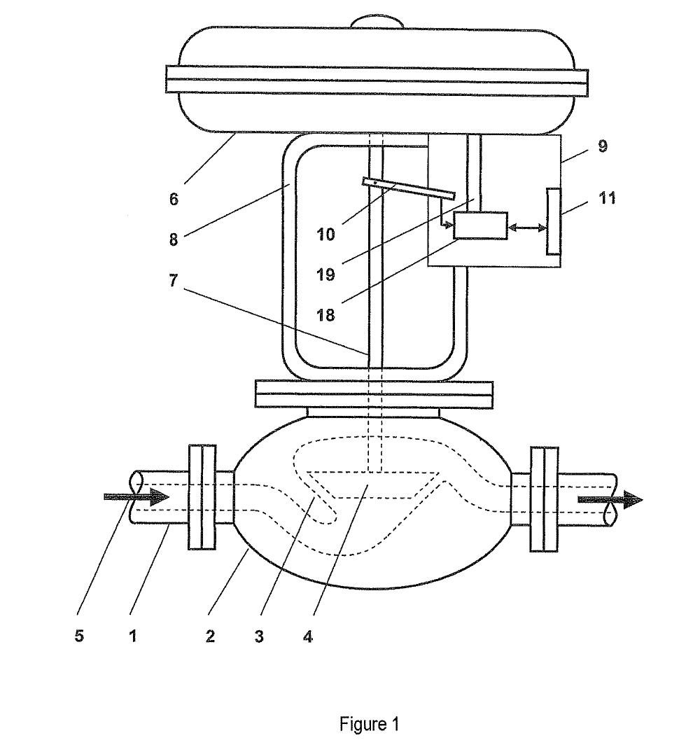

FIG. 1 shows an exemplary pipeline 1, indicated in fragmentary form, of an exemplary process installation, which is not illustrated in any more detail, with a process valve 2 installed in it. In its interior, the process valve 2 has a closure body 4, which interacts with a valve seat 3, in order to control the flow rate of the process medium 5. The closure body 4 is operated linearly by an actuating drive 6 via a valve rod 7. The actuating drive 6 is connected to the process valve 2 via a yoke 8. A position regulator 9 is fitted to the yoke 8. The movement of the valve rod 7 is signaled to the position regulator 9 via a position sensor 10. The detected movement is compared in a control unit 18 with the set value supplied via a communication interface 11, and the actuating drive 6 is driven as a function of the determined control error. The control unit 18 of the position regulator 9 has an I/P converter for conversion of an electrical control error to an adequate control pressure. The I/P converter of the control unit 18 is connected to the actuating drive 6 via a pressure medium supply 19.

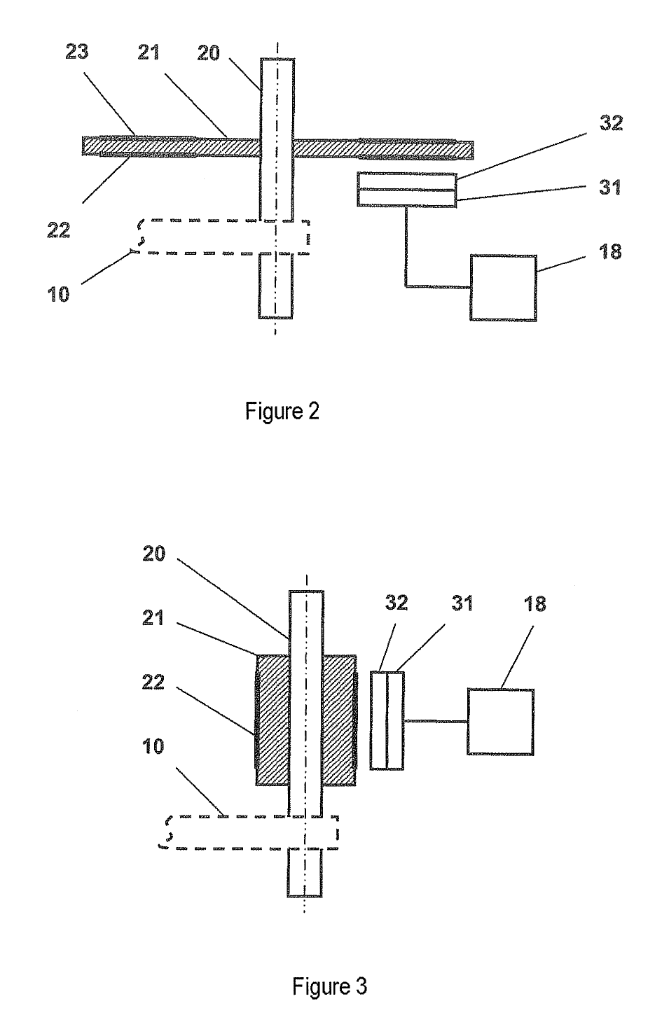

FIG. 2 shows a partially sectioned illustration of a first exemplary embodiment of a position detection device. A rotationally symmetrical pattern support 21 in the form of a disk is mounted on a shaft 20, which is rotated by the position sensor 10 as a function of the movement of the valve rod 7, and is mounted via the shaft 20 such that it can rotate. The surface is partially covered radially with a pattern 22 which can be scanned optically. In detail, a 16-bit Gray code can be applied to the pattern support 21.

The position detection device also has a scanning device, whose focus is directed at the pattern 22. The scanning device essentially comprises a sensor 31, on whose optical axis, pointing at the pattern 22, a lens 32 is arranged. The sensor 31 is connected to the control unit 18. In an exemplary embodiment, a CCD row is provided for the sensor 31.

The respective code can be read at the focus of the sensor 31 in order to determine the instantaneous position of the valve rod 7. In this case, provision can be made for the CCD row to have a multiple of the number of bits as the number of pixels. The excess pixels in the CCD row allow statistical and/or arithmetic assessment of the code sequence read at the focus. This can advantageously increase the position detection accuracy. In particular, for example, a mean value can be formed over the code sequence. This also compensates for slight dirt on the surface of the pattern support 21.

The pattern 22 on the pattern support 21 is in the form of a concentrically circumferential, annular track. This means that one section of the pattern 22 is always at the focus of the scanning device irrespective of the angular position of the pattern support 21. The angular resolution of about 20 arc seconds resulting from a 16-bit Gray code allows the position of the valve rod 7 to be determined sufficiently accurately by means of the position sensor 10.

Furthermore, the pattern 22, 23 in the form of concentrically circumferential annular tracks is coincident on both disk faces of the pattern support 21 which is in the form of a disk. In an exemplary embodiment, one of the tracks can be always at the focus of the scanning device, and the instantaneous position of the valve rod 7 can therefore be detected, irrespective of the installation orientation.

FIG. 3 shows a partially sectioned illustration of a second exemplary embodiment of a position detection device, in which the same reference symbols are used for the same means. A rotationally symmetrical pattern support 21 in the form of a roller is mounted on a shaft 20, which is rotated by the position sensor 10 as a function of the movement of the valve rod 7, and is mounted via the shaft 20 such that it can rotate. The casing of the pattern support 21 is partially covered by a pattern 22 which can be scanned optically. In detail, a 16-bit Gray code is applied to the pattern support 21.

The pattern support 21 has an associated scanning device, essentially comprising a sensor 31 and a lens 32, such that the pattern 22 is at the focus of the sensor 31. The sensor 31 is connected to the control unit 18. In an exemplary embodiment of the disclosure, a CCD row is provided for the sensor 31.

The pattern 22 on the pattern support 21 is in the form of a concentrically circumferential track, in the form of a tire. In an exemplary embodiment, this means that one section of the pattern 22 is always at the focus of the scanning device irrespective of the angular position of the pattern support 21. The angular resolution of about 20 arc seconds resulting from a 16-bit Gray code allows the position of the valve rod 7 to be determined sufficiently accurately via the position sensor 10.

This exemplary embodiment of the disclosure can be physically compact, occupying little space and therefore resulting in miniaturization.

A further exemplary version is provided for the above-described embodiments by the pattern support 21 being illuminated by an intermittent light source. The position detection device can therefore use requires less energy than if the pattern support were to be illuminated all the time. Furthermore, this operating mode is similar to the discontinuous method of operation of sequentially operated optical scanning devices and downstream processing means. In detail, an LED is provided for illumination of the pattern support 21.

In the case of a rotary drive, it is possible to provide for the pattern support 21 to be arranged directly on the rotation axis of the rotary drive.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Pipeline
2 Process valve
3 Valve seat
4 Closure body
5 Process medium
6 Actuating drive
7 Valve rod
8 Yoke
9 Position regulator
10 Position sensor
11 Communication interface
18 Control unit
19 Pressure medium supply
20 Shaft
21 Pattern support
22,23 Pattern
30 Scanning device
31 Sensor
32 Lens

What is claimed is:

1. An actuating drive for control of an actuating element comprising:
a position detection device configured for detection of an actual position of the actuating element;
a regulator unit configured for operational connection with the position detection device for comparison of an actual position with a predeterminable set position and for production of an actuating signal for driving the actuating drive, wherein the position detection device has a pattern support, at least part of whose surface is covered by a pattern which can be scanned optically; and
a stationary optical scanning device, whose optical axis is aligned with the pattern.

2. The actuating drive as claimed in claim 1, wherein the pattern support is rotationally symmetrical disk, and the pattern is arranged radially on the pattern support.

3. The actuating drive as claimed in claim 2, wherein the pattern is a concentrically circumferential, annular track.

4. The actuating drive as claimed in claim 3, wherein the pattern is concentrically circumferential, annular tracks that are coincident on both faces of the disk.

5. The actuating drive as claimed in claim 1, wherein the pattern support is a roller, and the pattern is arranged on a casing of the pattern support.

6. The actuating drive as claimed in claim 5, wherein the pattern is a concentrically circumferential track in the form of a tire.

7. The actuating drive as claimed in claim 1, wherein the pattern support is illuminated by an intermittent light source.

8. The actuating drive as claimed in claim 6, wherein the pattern support is illuminated by an intermittent light source.
